(19) United States
(12) Patent Application Publication
(10) Pub. No.: US 2009/0133770 A1
(43) Pub. Date: May 28, 2009

(54) Connection hose braided wire for sanitary appliances and connection hose therefor

(76) Inventor: Huiliang Pan, Ningbo (CN)

Correspondence Address: Xinsheng Wang;c/o Huiliang Pan, 19 Hemlock Drive, Syosset, NY, 11791, US

(21) Appl. No.: 12/290,108

(22) Filed: Oct. 28, 2008

(30) Foreign Application Priority Data
Nov. 23, 2007 (CN) 200720305130.1

(51) Int. Cl. F16L 11/00

(52) U.S. Cl. 138/127; 138/109; 138/125

(57) ABSTRACT

A connection hose braided wire includes a metallic wire (1) and a thin plastic protection layer (2) coated on the outer surface of the metallic wire. Wherein the metallic wire can be stainless steel wire of high strength, stainless iron wire of high strength or aluminum-alloy wire, and the plastic can be PE, PVC or PP. The present invention also relates to a connection hose formed by braiding the hose braided wires (3) on the outer surface of its inner pipe (4). The connection hose braided wire has higher strength, better corrosion resistance, higher environmental protection, more beautiful appearance and better touch, and can avoid rustiness of the hose and increase its service life. The connection hose can be used as connecting pipes for sanitary appliances etc.

### TECHNICAL FIELD

The present invention relates to a connection hose braided wire, which can be compactly braided on the outer surface of the inner pipe of the connection hose thereby to form the connection hose applicable to sanitary appliances in kitchens and toilets etc. The present invention also relates to the connection hose coated with said connection hose braided wires, which can be used for said sanitary appliances.

### BACKGROUND ART

Connection hoses are widely used in sanitary appliances in kitchens and toilets, which connection and fixing can be done in a simple and rapid way.

A connection hose in the prior art commonly consists of an inner pipe and an outer pipe of braided wires. For example, U.S. Pat. No. 4,159,027 describes a hose for connecting sanitary appliances, such as a lavatory supplied with water, to a water supply pipe, referring now to FIG. 1, this connection hose being constituted by a tubular core 10 made of supple elastomeric material, an outer protective sheath 11 constituted by a braid of strands of metallic wires, and each strand comprising between 3 and 8 parallel stainless steel wires, the strands forming intersecting helices.

However, said connection hose of this type has following shortcoming: Since the braided metallic wires of the outer pipe are usually stainless steel wires, after the hose has been used for a certain long time, the stainless steel wires easily rust, so it results in rustiness or water leakage even cracking of the entire hose. The shortcoming not only shortens the service life of the hose, but also often brings a user much incommodity in his living, even brings some losses of his belongings.

Furthermore, wire joints often appear during the braiding course or the use course of the braided metallic pipes, due to the wire breakage caused by a variety of reasons. Such wire joints may scratch braiders, installers or users during a braiding, installing or use course of the braided pipes. In addition, such braided pipes have poor tactility when touched.

### DISCLOSURE OF THE INVENTION

It is therefore an object of the present invention to overcome the above shortcomings of the prior art and provide a connection hose braided wire applicable to sanitary appliances, which can avoid rustiness of the hose and increase its service life.

Another object of the present invention is to provide a connection hose coated with said connection hose braided wires, such that water leakage and crack would not happen to the connection hose.

According to the present invention, the connection hose braided wire includes a metallic wire and a thin plastic protection layer coated on the outer surface of the metallic wire, thus a single connection hose braided wire is achieved.

Wherein said metallic wire can be stainless steel wire of high strength, stainless iron wire of high strength, ordinary steel wire or aluminum-alloy wire.

Wherein said plastic protection layer can be of polyethylene (PE), polyvinyl chloride (PVC), or polypropylene (PP) etc. It may be transparent or have various colors.

According to the present invention, the connection hose includes an inner pipe, and connection hose braided wires compactly braided on the outer surface of the inner pipe. Each connection hose braided wire consists of a metallic wire and a thin plastic protection layer coated on the outer surface of the metallic wire.

Wherein each end of the connection hose is provided with one pipe coupling, respectively. Each of the pipe couplings includes a nut, a nipple and a ferrule, and each end of the inner pipe is wedged into a corresponding cavity between the nipple and the ferrule.

Wherein one end of the ferrule extends into the nut at the corresponding end and recesses inwards so as to form an annular recess in which the bottom surface of the nut is embedded, the nipple passes through the nut and the ferrule. The ferrule, the hose and the nipple are tightly combined together by punching the ferrule at each end of the connection hose.

Wherein said metallic wire can be replaced by nonmetallic thread, such as polyamide fiber thread, acrylic fiber thread or polypropylene fiber thread, of high strength.

Therefore the advantages of the present invention are as follows:

(1) The strength of the connection hose is higher: The metallic wire of the braided wire is a steel wire of high strength and the outer surface of the steel wire is coated with a plastic protection layer, thus the connection hose has higher strength.

(2) The corrosion resistance of the braided wire is better: In the prior art, braided wires of a braided hose with stainless steel wires usually have been corroded after the hose has been used in an acid or alkaline environment over one year, and serious rustiness occurs on its surface. But according to the present invention, since the outer surface of the metallic wire of the connection hose braided wire is coated with a plastic protection layer of PE, PVC or PP etc., the protection layer makes the metallic wire separate from external environment, so the metallic wire will not rust.

(3) The braided wire has environmental protection performance: When the outer plastic protection layer is made from PE, the braided hose will not pollute our environment after it has been rejected.

(4) The appearance and touch of the connection hose are better: Since the metallic wire of the braided wire does not directly contact with air in various environments, it will not rust, then the appearance of the connection hose becomes more beautiful and its touch is very good. At the same time, it can avoid that wire joints come forth and then harmfully dub or scratch users' hands while the metallic wires are braided.

(5) Water leakage and crack would not happen to the connection hose: The nut of each pipe coupling is embedded into and connected with the ferrule by the annular recess at the end of the ferrule, so water leakage will not easily happen. Furthermore, both the nipple and the ferrule together bear the pulling force applied to the inner pipe and the pipe coupling owing to their connection and the shearing force caused by the punching force to the ferrule, it thus can avoid breakage of the nipple and cracking of the hose.

(6) Under the condition of equivalent mechanical property, for example strength of materials, the content of precious metals, such as Ni and Cr, in said metallic wire is low, which can reduce the material cost about 30% to 50%.

### BRIEF DESCRIPTION OF THE DRAWINGS

The present invention will be more specifically described below with reference to the attached drawings.

FIG. 1 is a part sectional view of a connection hose in the prior art.

FIGS. 2a and 2b are a longitudinal sectional view and a cross-sectional view of the connection hose braided wire according to the present invention, respectively.

FIG. 3 is a longitudinal sectional view of the present invention, wherein the connection hose braided wires have been braided on the outer surface of the inner pipe of the connection hose.

FIG. 4 is a part sectional view of the connection hose according to the present invention.

FIG. 5 is a part enlarged view I of the connection hose according to the present invention.

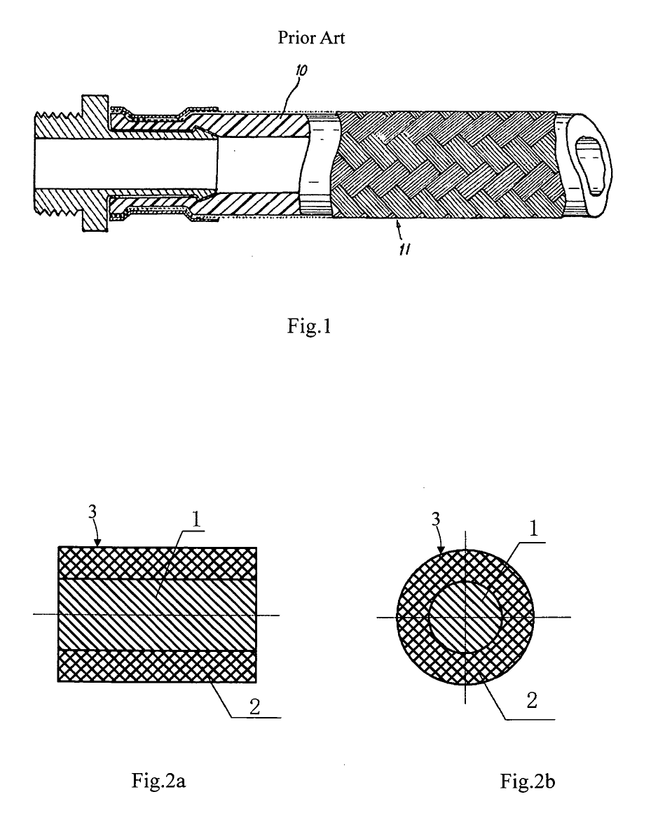

### BEST MODE FOR CARRYING OUT THE INVENTION

As shown in FIGS. 2a and 2b, the connection hose braided wire according to the present invention includes a metallic wire 1 and a thin plastic protection layer 2 coated on the outer surface of the metallic wire 1, thus a single connection hose braided wire is achieved.

Further, said metallic wire 1 can be stainless steel wire of high strength, stainless iron wire of high strength, any other ordinary steel wire, or aluminum-alloy wire.

Further, said plastic protection layer 2 can be of polyethylene (PE), polyvinyl chloride (PVC), or polypropylene (PP) etc. It may be transparent or have various colors.

Further, the diameter of said metallic wire 1 is in a range from 0.1 mm to 1 mm, perfectly from 0.18 mm to 0.3 mm. The unilateral thickness of said plastic protection layer 2 is in a range from 0.16 mm to 0.85 mm. Thus, the diameter of a single braided wire is perfectly in a range from 0.5 mm to 2 mm.

The plastic protection layer is coated on the metallic wire by means of an extruder. That is to say, plastic is heated and melted in the extruder and then passes through the moulds of the extruder such that the melted plastic can be coated on the metallic wires, and the braided metallic wires can be packaged after they are cooling and shaped. The detailed steps are as follows:

1) Setting the temperature of the extruder at 180° C., and switching on the electrical source of the heating zone of the extruder;

2) Feeding the metallic wires into a support of the extruder, then making them pass through the moulds of the extruder;

3) Heating plastic till it is melted;

4) Extruding the melted plastic by the extruder such that it is uniformly coated on the metallic wires;

5) Cooling and shaping the coated metallic wires by a cooling system;

6) Reeling in the coated metallic wires onto a roller as required so as to be used while braiding said braided hoses.

In order to identify the better performances of the present invention, now we take the braided wires made from steel wires coated with PVC as an example to test the performances of said braided wires. The test results are as follows:

1) Tensile strength

Before coated with PVC: the tensile strength of a single uncoated wire is 840 N/mm²,

After coated with PVC: the tensile strength of a single coated wire is 950 N/mm².

2) Extensibility

Before coated with PVC: the extensibility of a single uncoated wire is 35%, After coated with PVC: the tensile strength of a single coated wire is 49%.

3) Corrosion stability

Under the condition of PH=6 and the testing time is 96 hours:

To a single uncoated wire: rustiness has happen and spots have appeared,

To a single coated wire: not any rustiness and spot appeared.

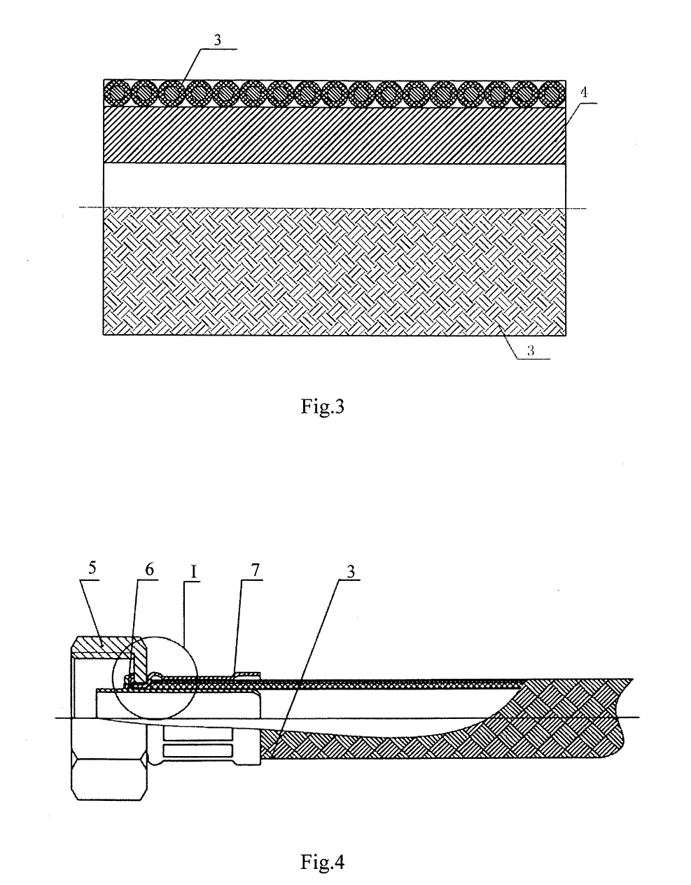

As shown in FIG. 3, the connection hose according to the present invention is formed by compactly braiding the connection hose braided wires 3 on the outer surface of the inner pipe 4 of the connection hose in a known braiding method.

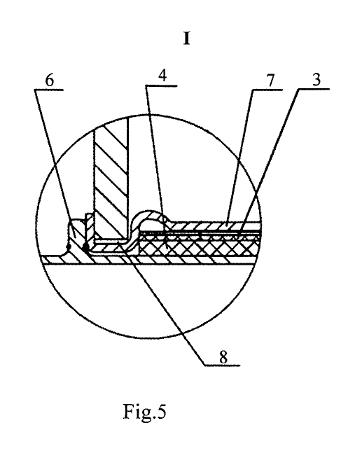

As shown in FIGS. 4 and 5, two pipe couplings are connected to two ends of the inner pipe 4 of the connection hose, respectively. Each pipe coupling includes a nut 5, a nipple 6 and a ferrule 7, and each end of the inner pipe 4 is wedged into a corresponding cavity between the nipple 6 and the ferrule 7. One end of the ferrule 7 extends into the nut 5 at the corresponding end and recesses inwards so as to form an annular recess 8 in which the bottom surface of the nut 5 is embedded, and the nipple 6 passes through the nut 5 and the ferrule 7. The ferrule 7, the hose and the nipple 6 are tightly combined together by punching the ferrule 7 at each end of the connection hose.

Said nut 5 is a type of nut having internal thread. The nut can be a hexagon nut, a striating nut or any type of nut. The standard of the nut is ¼″c, ⅜″c, ⅜″, ½″c, ½″, ¾↑, or 1″ etc. The nut can be made of a forged brass H59, or steel formed by stretching.

Said nipple 6 can be shaped by forging and turning or by form stretching. The material used for the nipple can be a forged brass H59, H62, H65 or H68, or stainless steel.

Said ferrule 7 can be made of H65 or steel.

Said metallic wire 1 can be replaced by nonmetallic thread, such as polyamide fiber thread, acrylic fiber thread or polypropylene fiber thread, of high strength.

Water leakage or crack would not happen to the connection hose according to the present invention even if the nipple has broken, so the connection hose is adequate for: (a) connection pipes for ice machines, (b) connection pipes for dishwashers, (c) connection pipes for faucets, (d) connection pipes for toilets, (e) connection pipes for water heaters, (f) connection pipes for washing machines, (g) connection pipes for shower baths, etc.

It will be appreciated from the foregoing description that the present invention provides a connection hose braided wire and a connection hose coated with the connection hose braided wire. Although the present invention has been described in relation to a particular exemplary embodiment, it should be understood that the skilled in the art could put in practice with various modifications or variants without thereby departing from its scope.

1. A connection hose braided wire for sanitary appliances includes a metallic wire (1) and a thin plastic protection layer (2) coated on the outer surface of the metallic wire (1) such that a single hose braided wire (3) is achieved.

2. The connection hose braided wire according to claim 1, wherein said metallic wire (1) is stainless steel wire of high strength, stainless iron wire of high strength, ordinary steel wire, or aluminum-alloy wire.

3. The connection hose braided wire according to claims 1 or 2, wherein said plastic protection layer (2) is of polyethylene, polyvinyl chloride, or polypropylene.

4. The connection hose braided wire according to claim 3, wherein said plastic protection layer (2) is transparent.

5. The connection hose braided wire according to any of claims 1 to 3, wherein the diameter of said metallic wire (1) is in a range from 0.1 mm to 1 mm.

6. The connection hose braided wire according to claim 5, wherein the diameter of said metallic wire (1) is in a range from 0.18 mm to 0.3 mm.

7. The connection hose braided wire according to any of claims 3 to 5, wherein the unilateral thickness of said plastic protection layer (2) is in a range from 0.16 mm to 0.85 mm.

8. The connection hose braided wire according to claim 1, wherein said metallic wire (1) can be replaced by nonmetallic thread, such as polyamide fiber, acrylic fiber or polypropylene fiber, of high strength.

9. A connection hose for sanitary appliances comprises an inner pipe (4), wherein the outer surface of the inner pipe (4) is compactly braided with connection hose braided wires (3) which includes a metallic wire (1) and a thin plastic protection layer (2) coated on the outer surface of the metallic wire (1).

10. The connection hose according to claim 9, wherein said metallic wire (1) can be replaced by nonmetallic thread, such as polyamide fiber, acrylic fiber or polypropylene fiber, of high strength.

11. The connection hose according to claims 9 or 10, wherein each end of the connection hose is provided with one pipe coupling, respectively; each pipe coupling includes a nut (5), a nipple (6) and a ferrule (7), and each end of the inner pipe (4) is wedged into a corresponding cavity between the nipple (6) and the ferrule (7).

12. The connection hose according to claim 11, wherein one end of the ferrule (7) extends into the nut (5) at the corresponding end and recesses inwards so as to form an annular recess (8) in which the bottom surface of the nut (5) is embedded, and the nipple (6) passes through the nut (5) and the ferrule (7); the ferrule (7), the hose and the nipple (6) are tightly combined together by punching at each end of the connection hose.
